(19) United States
(12) Patent Application Publication
(10) Pub. No.: US 2002/0184478 A1
(43) Pub. Date: Dec. 5, 2002

(54) Instruction path coprocessor branch handling mechanism

(76) Inventors: Adrianus Josephus Bink, Chicago, IL (US); Alexander Augusteijn, Eindhoven (NL); Paul Ferenc Hoogendijk, Eindhoven (NL); Hendrikus Wilhelmus Johannes Van De Wiel, Eindhoven (NL)

Correspondence Address: U.S. Philips Corporation, 580 White Plains Road, Tarrytown, NY, 10591, US

(21) Appl. No.: 10/117,850

(22) Filed: Apr. 8, 2002

(30) Foreign Application Priority Data
Apr. 11, 2001 (EP) 01201340.5

(51) Int. Cl. G06F 15/00

(52) U.S. Cl. 712/235; 712/34; 712/237

(57) ABSTRACT

The problem of mis-match between a program counter (14) of a CPU (10) and a byte code counter (18) of an instruction path coprocessor (IPC) (16) is addressed by causing the IPC (16) to translate IPC branch instructions to the CPU branch instructions, in which the CPU branch instructions implicitly indicate whether a corresponding IPC branch instructions should be taken and in which the CPU branch instruction will cause the CPU (10) to set its own program counter (14) to a safe location in the IPC range to avoid overflow.

This invention relates to data processing apparatus for instruction path coprocessor branch handling and to a method of handling branch instructions in an instruction path coprocessor.

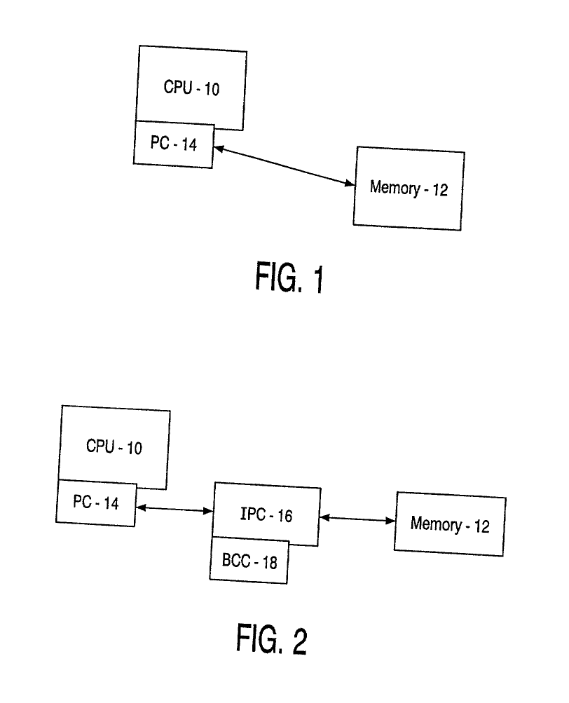

Referring to FIG. 1 a central processing unit (CPU) 10 typically reads and executes instructions stored in a memory 12. A program counter (PC) 14 indicates to the CPU 10 the address of a particular instruction in the memory 12, allowing the CPU 10 to access a relevant instruction and perform the execution thereof.

Data path coprocessors can be used to speed up execution of instructions in a computing system including a central processing unit (CPU). Similarly, an instruction path coprocessor (IPC) 16, as shown in FIG. 2, is used to help a processor fetch and decode instructions. An IPC 16 has its own instruction set architecture (ISA). The IPC 16 fetches its own IPC instructions, decodes the instructions and translates them to a CPU instruction. The IPC then sends these generated instructions to the CPU 10 for execution.

Typically, an IPC 16 is activated by defining a CPU range (the so-called IPC range) to which the IPC 16 is sensitive. If the CPU 10 tries to fetch an instruction from within that range, the IPC 16 intercepts this fetch and generates a CPU instruction from an IPC 16 instruction fetched by the IPC 16 itself. When such an IPC 16 is combined with a CPU 10 the following problems exist.

An IPC has its own program counter, called a byte code counter BCC 18, and is only indirectly aware of the CPU's program counter (PC) 14. When the IPC 16 decodes an IPC branch instruction and generates a CPU branch instruction, then that branch instruction will directly effect the CPU's program counter 14. However, the BCC 18 will not change accordingly. This results in a mis-match between the value of the program counter 14 and the BCC 18, which problem must be addressed.

It is important to note that the IPC 16 may have a different ISA to the CPU 10. If so, and the instructions in the IPC ISA have a different length to those in the CPU ISA, the IPC has to keep track of the current position in a program with the BCC 10.

A second problem is that the CPU 10 can run or jump out of the IPC range causing an unwanted deactivation of the IPC 16, because the IPC 16 is deactivated when the CPU 10 is out of the IPC range.

It will be apparent that these problems only exist in the case where the BCC 18 and PC 14 are not coupled in a trivial way (for example where BCC=PC÷4). In the case of a variable length IPC code which translates to fixed length CPU code, such a clear coupling between BCC 18 and PC 14 cannot be given.

The first problem mentioned above can be solved by either explicit or implicit communication of the CPU 10 with the IPC. The explicit communication is achieved as follows:

upon receiving an IPC branch instruction, the IPC 16 generates native instructions which cause the CPU 10 to write its status (and/or the destination address) to the IPC, which can then decide whether and where to branch.

The implicit communication is achieved as follows:

upon receiving an IPC branch instruction, the IPC 16 generates a native instruction (branch) which causes the CPU 10 to have an observable behaviour on its address lines, which can be used to determine whether the corresponding IPC branch should be taken or not.

The second problem mentioned above (i.e. the out of range problem) can be solved by having the IPC generating additional branches (i.e. no corresponding branch exists in IPC code) into the IPC range whenever the CPU is close to running out of that range.

The prior solution of the two problems mentioned above is by separate action to solve each of the problems separately.

U.S. Pat. No. 6,021,265 discloses an instruction decoder which is responsive to bits of the program counter register.

It is an object of preferred embodiments of the present invention to address the two above mentioned problems simultaneously. It is a further object of preferred embodiments of the present invention to simultaneously address the two problems mentioned above by means of low cost application.

It is a further object of preferred embodiments of the invention to make the operation of an instruction path coprocessor more efficient.

According to a first aspect of the present invention a data processing apparatus for instruction path coprocessor branch handling comprises a central processing unit (CPU) having a program counter (PC) and an instruction path coprocessor (IPC), characterised in that the IPC is operable to compute a branch target address for a corresponding branch instruction that is used to read out address status information of the CPU, and the program counter of the CPU is operable to be adjusted so that a current address value therein falls within an active address range of the IPC.

The amendment of the address value advantageously and cheaply prevents overflow in the IPC by retaining an address value within the IPC range.

The program counter may be operable so that an address value therein is adjusted so that the address value remains in the active address range of the IPC. Preferably, the address value is adjusted downwards, most preferably to a value close to the lower limit of the active address range of the IPC. Preferably, the downward adjustment is by approximately N address values, where N is a number of sequential instructions which the IPC cannot exceed.

The program counter may be operable so that an address value thereof is adjustable by a fixed offset, preferably of an even number of address values.

This allows a determination of whether or not a branch has been take from the least significant bit (LSB) of the program counter, discarding a few less significant bits if necessary, due to multibyte instruction lengths.

The invention extends to a cell phone, set-top box or handheld computer fitted with the apparatus of the first aspect.

According to a second aspect of the present invention, a method of handling branch instructions in an instruction path coprocessor (IPC) and central processing unit (CPU) is characterised by the method comprising the IPC computing a branch target address for a corresponding branch instruction, which branch target address allows a read out of address status information of the CPU; adjusting a program counter of the CPU, based on the information from the previous step, so that a current address value therein falls within an active address range of the IPC, to thereby prevent overflow of the IPC.

The program counter may be adjusted so that the address value is amended from a first value in the IPC active address range to a second value in the IPC active address range. Preferably, the first value is higher in the IPC active address range than the second value. Preferably, the second value is close to a lower limit of the IPC active address range.

The adjustment of the program counter may be by a fixed offset, preferably an even number of address values.

All of the features described herein maybe combined with any of the above aspects, in any combination.

These and other aspects of the invention will be apparent from and illustrated with reference to the embodiment described hereinafter.

FIG. 1 is a schematic block diagram of a CPU and memory set up;

FIG. 2 a schematic block diagram of a CPU and an instruction path coprocessor linked to a memory store; and

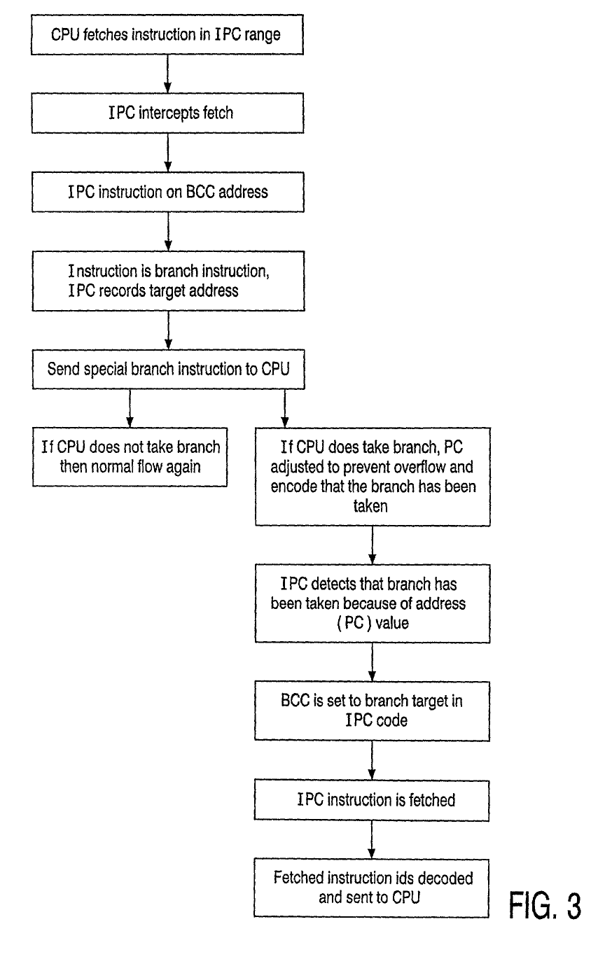

FIG. 3 is a flow chart showing the stages in the operation of a first embodiment of the present invention.

The problem of mis-match between the program counter 14 of the CPU 10 and the byte code counter 18 of the IPC 16 is addressed, as set out in FIG. 3, by causing the IPC 16 to translate IPC branch instructions to native (CPU) branch instructions, which have both of the following characteristics:

the native (CPU) branch instruction will implicitly indicate whether the corresponding IPC branch instruction should be taken, by being in the IPC range, or not in the IPC range, as the case may be.

also, the native (CPU) branch instruction will cause the CPU 10 to set its program counter 14 to a safe location in the IPC (so that even after N successive sequential instructions the program counter 14 would still be in the IPC range, where N is an integer).

Given that in an IPC program the maximum number of sequential instructions can never exceed N, the program counter 14 of the CPU 10 is reset to a value in the IPC range without further action, i.e. no extra branch instructions have to be generated by the IPC 16, nor does the IPC 16 need to be programmed to take account of the CPU 10 running out of the IPC range unintentionally. More specifically, the embodiment can be put into effect by the following implementation.

| | | | GENERATED CPU |
|---|---|---|---|
| PC | BCC | IPC INSTRUCTION | INSTRUCTION |
| 0x80000010 | 0x000007 | IPC_SUB | CPU_SUB |
| 0x80000014 | 0x000008 | IPC_BNE#0x30 | CPU_BNE#offset |
| 0x80000018 | 0x00000a | IPC_don't_care | CPU_don't_care |
| 0x8000001c | 0x00000b | IPC_don't_care | CPU_don't_care |
| 0x80000004 | 0x000038 | IPC_LD | CPU_LD |

In the example the most significant program counter bit is taken to indicate the IPC range, so for every instruction fetch from an address with PC(31)==“1”, an IPC instruction will be translated to a CPU instruction which will be sent to the CPU 10. For sequential flow, a counter of the program counter 14 increases with the CPU instruction size (in this example 4 bytes) for every instruction fetch. The BCC 18 of the IPC 16 increases with a variable number of bytes, because the IPC instructions vary in length. The IPC branch instruction (in this example IPC_BNE#×30) is translated to a CPU branch instruction which, when taken, leads to a branch in the CPU (after two branch delay slots) which can be easily observed by looking at consecutive values of the program counter 14. Here, it is only necessary to look at PC(2) (two values of the program counter 12) to see if a branch has been taken or not (two even, or two odd word addresses in a row indicate a taken branch). The other thing that happens (without further programming necessary) is that the program counter 14 is reset to an address at the beginning of the IPC range (in this example 0×80000004 or 0×80000000, dependent upon whether an even, or an odd word program counter value 14 is required to indicate a taken branch).

In order to achieve implementation of the above, the IPC 16 has to generate an appropriate offset, which can be done as follows (for a 32-bit PC, a 24-bit offset, and a 24-bit BCC):

Offset=0×800000¦(((˜ba)>>2)&0×fffffe),

where

the “0×800000” makes sure that the offset will be negative (so that we branch back in the direction of the IPC range start address)

the ba is the PC location of the relative branch instructions and ˜ba is a cheap and fast way to get almost the value of −ba; to be precise, ˜ba=−ba−1.

the “>>2” is needed for offsets that count in words instead of bytes.

the “0×fffffe” guarantees that taken branches always branch an even number of words further so that they can be detected (as a non-taken branch results in sequential flow which means that the address is increased by an odd number of words (i.e. one word further)).

On the CPU 10 (with 2 delay slots), the following will happen for a taken branch:

Target PC =(PC+8)+SEXT(offset)<<2

=(PC+8)+SEXT(0×800000¦(((˜PC)>>2)&0×fffffe))<<2

=(PC+8)+SEXT(0×800000¦(((−PC−1)>>2)&0×fffffe))<<2

=(PC+8)+(0×fe000000¦((−PC−1−3)&0×3fffff8))

=(PC&0×fe000000)¦(0×4 for odd word PC, 0×0 for even word PC)

The embodiment described above can be put into practice in a ThumbScrews Decoder, which is an IPC that converts the compact ThumbScrews instruction set to an ARM code. A ThumbScrews Decoder can be used in products like GSM telephones, television set-top boxes and hand-held PCs which contain megabytes of embedded software. With code compaction techniques (and the corresponding decoder), it is possible to reduce the required memory size, and associated cost, when compared to currently leading processors like ARM Thumb. Similarly, the described techniques can be used in VMI which is another IPC that translates Java byte code to MIPS code.

From the aforegoing, it will be appreciated that the implementation of the embodiment described above results in more efficient virtual machine programming execution.

By suitable use of the IPC and adjustment of the address information to a value which retains the address in the IPC range, overflow can be prevented. At the same time the generation of extra branch instructions, as required by the prior art method of solving the stated problem, is avoided.

1. A data processing apparatus for instruction path coprocessor branch handling comprises a central processing unit (CPU) (10) having a program counter (PC) (14) and an instruction path coprocessor (IPC) (16), characterised in that the IPC (16) is operable to compute a branch target address for a corresponding branch instruction that is used to read out address status information of the CPU (10), and the PC (14) of the CPU (10) is operable to be adjusted so that a current address value therein falls within an active address range of the IPC (16).

2. A data processing apparatus as claimed in claim 1, in which the PC (14) is operable so that an address value therein is adjusted so that the address value remains in the active address range of the IPC (16).

3. A data processing apparatus as claimed in either claim 1 or claim 2, in which the address value is adjusted downwards.

4. A data processing apparatus as claimed in any preceding claim, in which the address value is adjusted to a value close to the lower limit of the active address range of the IPC (16).

5. A data processing apparatus as claimed in any one of claims 3 or 4, in which the downward adjustment is by approximately N address values, where N is a number of sequential instructions which the IPC (16) cannot exceed.

6. A data processing apparatus as claimed in any preceding claim, in which the PC (14) is operable so that an address value thereof is adjustable by a fixed offset.

7. A cell phone, set top box or hand held computer fitted with the apparatus claimed in any one of claims 1 to 6.

8. A method of handling branch instructions in an instruction path coprocessor (IPC) (16) and central processing unit (CPU) (10) is characterised by
the IPC (16) computing a branch target address for a corresponding branch instruction, which branch target address allows a read out of address status information of the CPU (10);
adjusting a program counter (PC) (14) of the CPU (10), based on the information from the previous step, so that a current address value therein falls within an active address range of the IPC (16), to thereby prevent overflow of the IPC (16).

9. A method as claimed in claim 8, in which the PC (14) is adjusted so that the address value is amended from a first value in the IPC active address range to a second value in the IPC active address range, in which the first value is higher than the second value.

10. A method as claimed in claim 9, in which the second value is close to a lower limit of the IPC active address range.

11. A method as claimed in any one of claims 8 to 10, in which the adjustment PC (14) is by a fixed offset.
